(19) United States
(12) Patent Application Publication
(10) Pub. No.: US 2009/0277567 A1
(43) Pub. Date: Nov. 12, 2009

(54) Method of fabricating substrate of paper-made food container

(76) Inventor: Hsi-Ching Chang, Taichung (TW)

Correspondence Address: HSI-CHING CHANG, P.O.BOX 215, TAICHUNG, 40099, TW

(21) Appl. No.: 12/230,727

(22) Filed: Sep. 4, 2008

(30) Foreign Application Priority Data
May 9, 2008 (TW) 097117296

(51) Int. Cl. B32B 37/14

(52) U.S. Cl. 156/79

(57) ABSTRACT

A method of fabricating a substrate of a paper-made food container includes: (1) a paper layer of an original paper roll is processed with preheating and electrostatic process in advance, and a gelatin film then is coated on a single face lamination or double face lamination of the paper layer to form a complex layer. Alternatively, the double face lamination does not to be coated. The gelatin film is biodegradable material or non-biodegradable material. (2) Biodegradable material or non-biodegradable material is utilized to prepare an electronic cross-linked foam layer as a roll. (3) The complex layer is conveyed to the continuous thermal laminator. The thermal processing device of the continuous thermal laminator then is utilized to perform melting point heating for one face lamination or double face laminations of surfaces between the complex layer and the electronic cross-linked foam layer. Two rollers of the rolling (laminating) device then roll the complex layer and the electronic cross-linked foam layer to form the substrate that can be subsequently cut to make various food containers having heat insulation, warm-keeping and cold insulation functions.

### FIELD OF THE INVENTION

The present invention relates to a method of fabricating a substrate of a paper-made food container to roll a complex layer and an electronic cross-linked foam layer through a continuous laminator, thereby becoming a whole.

### BACKGROUND OF THE INVENTION

In the present published information, an prior art “Substrate structure for manufacturing paper-made food container” applied by the applicant was granted and includes two independent claims and three dependent claims respectively depended upon the foregoing two independent claims. The independent claims respectively include “A Substrate structure for manufacturing a paper-made food container, comprising: a paper layer and at least one or two biodegradable foam layers, which are made of supercritical carbon dioxide microcellular foaming in extrusion process, thermally pressed to and adhered to a single face or double face.” and “A Substrate structure for manufacturing a paper-made food container, comprising: a paper layer and at least one surface or two surfaces coated with cross-linked coating layer, wherein a surface of the cross-linked coating layer is thermally pressed to and adhered to a biodegradable foam layer made of supercritical carbon dioxide microcellular foaming in extrusion process.”

The foregoing patent applicant utilizes thermal press technique to combine the paper layer and the biodegradable foam layer to form a whole, thereby making the substrate that can be completely composted without polluting environment. However, before initially inventing the structure, the applicant only pays attention to the substrate structure for paper-made food container having environmental protection without pollution, and does not concern different kinds of factors such as manufacture costs and acceptability of consumable containers at high price for markets. Consequently, the structure is difficult to popularize small restaurant industry in general.

Accordingly, to overcome the foregoing shortcomings, the inventor(s) of the present invention based on years of experience in the related field to conduct extensive researches and experiments, and finally invented a method of fabricating a substrate of a paper-made food container.

### SUMMARY OF THE INVENTION

A primary goal of the present invention is to provide a method of fabricating a substrate with low manufacture cost and simple process for subsequently making a food container. The method can utilize a thermal processing device of a continuous laminator to heat a surface of a complex layer to achieve the melting point. The surface then is combined with a foam layer and the complex layer and the foam layer are rolled by a rolling (laminating) device to closely become a whole. In addition, the thermal processing device of the continuous laminator can be utilized to heat the surface of the foam layer on a paper layer of an original paper roll in advance. The foregoing paper layer and the foam layer are rolled by the rolling (laminating) device to become a whole closely.

To achieve the foregoing object, the method of fabricating the substrate of the paper-made food container includes the following steps:
(1) The paper layer of the original paper roll is processed with preheating and electrostatic process in advance. A gelatin film then is coated on a single face lamination or double face lamination of the paper layer to form a complex layer. Alternatively, the double face lamination does not to be coated. The gelatin film is biodegradable material or non-biodegradable material.
(2) Biodegradable material or non-biodegradable material is utilized to prepare an electronic cross-linked foam layer as a roll.
(3) The complex layer is conveyed to the continuous thermal laminator in advance. The thermal processing device of the continuous thermal laminator then is utilized to perform melting point heating for surfaces between the complex layer and the electronic cross-linked foam layer. Two rollers of the rolling (laminating) device roll the complex layer and the electronic cross-linked foam layer to form the substrate that can be subsequently cut to make various food containers having heat insulation, warm-keeping and cold insulation functions.

A second object of the present invention is to provide a method of fabricating the substrate of the paper-made food container that further includes the following steps:
(1) A paper layer of an original paper roll is prepared;
(2) Biodegradable material or non-biodegradable material is utilized to prepare an electronic cross-linked foam layer as a roll; and
(3) The complex layer and the electronic cross-linked foam layer are conveyed to the continuous thermal laminator. The thermal processing device of the continuous thermal laminator then is utilized to heat surfaces between the complex layer and the electronic cross-linked foam layer. Two rollers of the rolling (laminating) device roll the complex layer and the electronic cross-linked foam layer to form the substrate that can be subsequently cut to make various food containers having heat insulation, warm-keeping and cold insulation functions.

Other features and advantages of the present invention and variations thereof will become apparent from the following description, drawings, and claims.

### BRIEF DESCRIPTION OF THE DRAWINGS

FIG. 1 is a schematic diagram illustrating a flow path of fabricating a substrate according to an embodiment of the invention.

### DETAILED DESCRIPTION OF THE PREFERRED EMBODIMENTS

Other features and advantages of the present invention will become apparent from the following description of the invention which refers to the accompanying drawings.

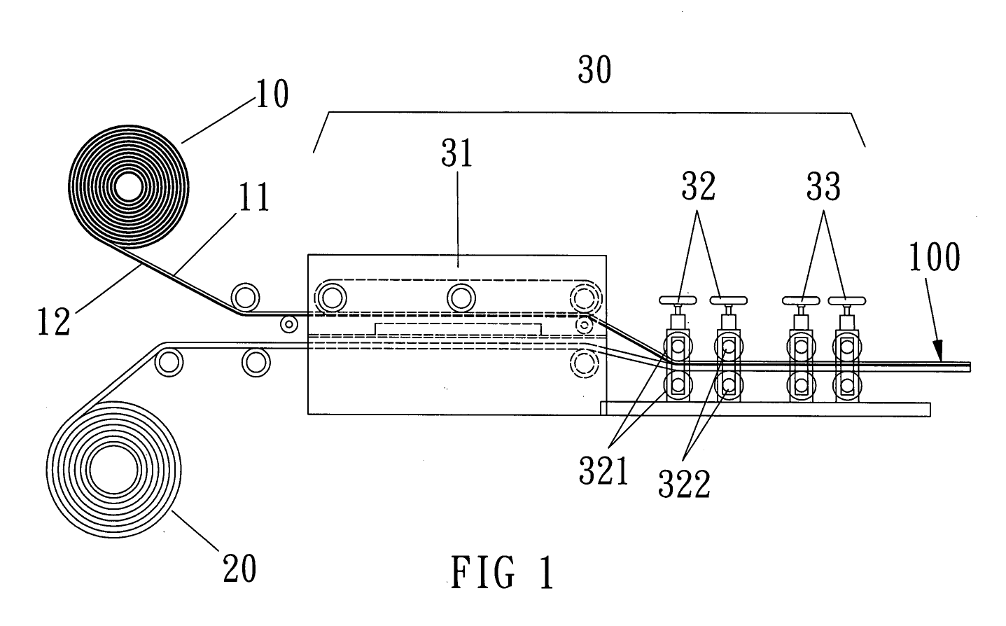

First, as shown in FIG. 1, a method of fabricating a substrate of a food container is disclosed, and includes the following steps:
(1) The process for a complex layer 10: a paper layer 11 of an original paper roll (not shown) is processed with preheating and electrostatic processes in advance. A laminated gelatin film 12 made of a laminating machine then is uniformly coated on a single face lamination or double face laminations of the paper layer 11 to form the complex layer 10 as a roll. Alternatively, the double face laminations may not be coated. The gelatin film 12 can be biodegradable material such as (PLA) gelatin film or starch gelatin film refined from plants, and can be non-biodegradable material, including any one of polyethylene (PE) thin film, polyethylene terephthalate (PET) film layer, polypropylene (PP) thin film, low density polyethylene (LDPE) thin film or high density polyethylene (HDPE) thin film refined by petroleum.
(2) An electronic cross-linked foam layer 20 is composed of physical cross-linked incorporated with foam material, and has better functions of heat insulation, cold insulation and warm-keeping. The electronic cross-linked foam layer 20 further includes waterproof, oil-proof, moistureproof, high temperature resistance and acid-base resistance. The appearance of the electronic cross-linked foam layer 20 is smoother than conventional expandable polystyrene (EPS) or polystyrene foams, and may not easily denaturalize, and can be easily processed. The foam material is any one of biodegradable poly lactic acid (PLA), or poly hydroxyl-carboxylic acid ester, poly hydroxyl butyrate (PHB), polyethylene terephthalate (Biomax PET), copolyester biodegradation, polyethylene terephthalate (PET) provided by Biomax, Germany, degradable plastic material (Ecoflex), non-genetically modified cornstarch (Mater-Be). Alternatively, the foam material can be any one of non-biodegradable polyethylene terephthalate (PET), or polypropylene (PP), or polyethylene (PE), or low density polyethylene (LDPE) or high density polyethylene (HDPE).
(3) A continuous thermal laminator 30: the complex layer 10 as the roll and the electronic cross-linked foam layer 20 are conveyed to the continuous thermal laminator 30. A thermal processing device 31 of the continuous thermal laminator 30 is utilized to perform melting point heating for one face lamination or double face laminations, which are not coated, of surfaces between the complex layer 10 and the electronic cross-linked foam layer 20. The complex layer or double face laminations of the layer 10 which are not coated and the electronic cross-linked foam layer 20 then are conveyed to the rolling (laminating) device 32, and rolled by two rollers 321 of the rolling (laminating) device 32 to form a substrate, thereby completing the substrate for food containers of the present invention. The substrate can be subsequently processed with printing, die-cutting and embossing to manufacture various food containers having functions of heat insulation, warm-keeping and cold insulation.

Moreover, the interior of the thermal processing device 31 of the continuous thermal laminator 30 has a conveyor platform for carrying the complex layer 10. The continuous thermal laminator 30 can be any one of an electric heating device, a hot blast device, a high frequency thermal processing device, an ultrasonic thermal processing device or a flame thermal processing device. In addition, the rolling (laminating) device 32 is composed of two rollers 321 capable of adjusting spacing. The interior of the rollers 321 can be equipped with a low temperature device 322 to enable the rollers 321 to simultaneously have cooling setting. Further, a flat-rolling device 33 can be disposed to the rear of the rolling (laminating) device 32 of the continuous thermal laminator 30 to flat the substrate 100 which is initially laminated as a whole.

Another method of fabricating a substrate of a food container includes the following steps:
(1) A paper layer of an original paper roll is processed with preheating and electrostatic process in advance.
(2) An electronic cross-linked foam layer is made of physical cross-linked incorporated with foam material, and has better functions of heat insulation, cold insulation and warm-keeping. The electronic cross-linked foam layer further includes waterproof, oil-proof, moistureproof, high temperature resistance and acid-base resistance. The appearance of the electronic cross-linked foam layer is smoother than conventional expandable polystyrene (EPS) or polystyrene foams, and may not easily denaturalize, and can be easily processed. The foam material is any one of biodegradable poly lactic acid (PLA), or poly hydroxyl-carboxylic acid ester, poly hydroxyl butyrate (PHB), polyethylene terephthalate (Biomax PET), copolyester biodegradation, polyethylene terephthalate (PET) provided by Biomax, Germany, degradable plastic material (Ecoflex), non-genetically modified cornstarch (Mater-Be). Alternatively, the foam material can be any one of non-biodegradable polyethylene terephthalate (PET), or polypropylene (PP), or polyethylene (PE), or low density polyethylene (LDPE) or high density polyethylene (HDPE).
(3) The complex layer as the roll and the electronic cross-linked foam layer are conveyed to a continuous thermal laminator. The thermal processing device of the continuous thermal laminator is utilized to directly heat surfaces between the complex layer and the electronic cross-linked foam layer by giving proper temperature. The complex layer and the electronic cross-linked foam layer then are combined through a rolling (laminating) device, and are rolled by two rollers of the rolling (laminating) device to form a substrate, thereby completing the substrate for food containers of the present invention. The substrate can be subsequently processed with printing, die-cutting and embossing to manufacture various food containers having functions of heat insulation, warm-keeping and cold insulation. The thermal processing device can be any one of an electric heating device, a hot blast device, a high frequency thermal processing device, an ultrasonic thermal processing device or a flame thermal processing device.

After the complex layer or the double face laminations which are not coated and the electronic cross-linked foam layer are conveyed to the thermal processing device of the continuous thermal laminator, the complex layer or the double face lamination of the layer and the electronic cross-linked foam layer are simultaneously preheated except the foregoing two procedures for the method of fabricating the substrate of the food container. Afterward, the complex layer and the electronic cross-linked foam layer then are rolled to become a whole.

When the substrate formed by the complex layer and the electronic cross-linked foam layer is utilized to make a cup, the substrate must be processed with printing, die-cutting and embossing. The substrate then is pressed by a forming machine to form a semi-finished good as a cup body. Another substrate is processed with die-cutting to form a circular cup bottom. The paper cup machine is utilized to assemble the cup body and the circular cup bottom to form a cup having the cup bottom. The foam layer of the formed cup can be at inside or outside. When the foam layer of the cup is at inside and the paper is at outside, the printing quality is quite well.

Although the features and advantages of the embodiments according to the preferred invention are disclosed, it is not limited to the embodiments described above, but encompasses any and all modifications and changes within the spirit and scope of the following claims.

What is claimed is:

1. A method of fabricating a substrate of a paper-made food container, comprising:
(a) coating a gelatin film on a single face lamination or double face lamination of paper layer of an original paper roll to prepare a complex layer;
(b) utilizing biodegradable material or non-biodegradable material to prepare an electronic cross-linked foam layer as a roll; and
(c) thermally pressing the complex layer or the electronic cross-linked foam layer through a continuous thermal laminator to prepare the substrate of the paper-made food container.

2. The method as claimed in claim 1, wherein a material of the gelatin film is the biodegradable material.

3. The method as claimed in claim 3, wherein the gelatin film is polylactic acid (PLA) gelatin film or starch gelatin film refined from plants.

4. The method as claimed in claim 1, wherein a material of the gelatin film is non-biodegradable material.

5. The method as claimed in claim 4, wherein the gelatin film is any one of polyethylene (PE) thin film, Polyethylene terephthalate (PET) film layer, polypropylene (PP) thin film, low density polyethylene (LDPE) thin film or high density polyethylene (HDPE) thin film refined by petroleum.

6. The method as claimed in claim 1, wherein the electronic cross-linked foam layer is any one of poly lactic acid or poly hydroxyl-carboxylic acid ester, and foamed by way of physical cross-linked.

7. The method as claimed in claim 1, wherein the electronic cross-linked foam layer is any one of Polyethylene terephthalate (PET) ester, or polypropylene (PP), or polyethylene (PE), or low density polyethylene (LDPE), or high density polyethylene (HDPE), and foamed by way of physical cross-linked.

8. The method as claimed in claim 1, wherein the continuous thermal laminator has a thermal processing device capable of performing melting point heating for surfaces between the complex layer and the electronic cross-linked foam layer.

9. The method as claimed in claim 8, wherein the thermal processing device is any one of an electric heating device, a hot blast device, a high frequency thermal processing device, an ultrasonic thermal processing device or a flame thermal processing device.

10. The method as claimed in claim 1, wherein the continuous thermal laminator has a rolling (laminating) device capable of rolling the complex layer and the electronic cross-linked foam layer to become to become a whole.

11. The method as claimed in claim 10, wherein the rolling (laminating) device is composed of two rollers capable of adjusting spacing.

12. The method as claimed in claim 12, wherein an interior of the roller has a low temperature device.

13. A method of fabricating a substrate of a paper-made food container, comprising:
(a) preparing a paper layer of a paper roll;
(b) utilizing biodegradable material or non-biodegradable material to prepare an electronic cross-linked foam layer as a roll; and
(c) thermally pressing the complex layer or the electronic cross-linked foam layer through a continuous thermal laminator to prepare the substrate of the paper-made food container.

14. The method as claimed in claim 13, wherein the electronic cross-linked foam layer is any one of acetic acid or poly hydroxyl-carboxylic acid ester, and foamed by way of physical cross-linked.

15. The method as claimed in claim 13, wherein the electronic cross-linked foam layer is any one of Polyethylene terephthalate (PET) ester, or polypropylene (PP), or polyethylene (PE), or low density polyethylene (PE), or high density polyethylene (PE), and foamed by way of physical cross-linked.

16. The method as claimed in claim 13, wherein the continuous thermal laminator has a thermal processing device capable of heating surfaces between the complex layer and the electronic cross-linked foam layer.

17. The method as claimed in claim 16, wherein the thermal processing device is any one of an electric heating device, a hot blast device, a high frequency thermal processing device, an ultrasonic thermal processing device or a flame thermal processing device.

18. The method as claimed in claim 13, wherein the continuous thermal laminator has a rolling (laminating) device capable of rolling the complex layer and the electronic cross-linked foam layer to become to become a whole.

19. The method as claimed in claim 18, wherein the rolling (laminating) device is composed of two rollers capable of adjusting spacing.

20. The method as claimed in claim 19, wherein an interior of the roller has a low temperature device.
